(19) United States
(12) Patent Application Publication
(10) Pub. No.: US 2026/0133122 A1
(43) Pub. Date: May 14, 2026

(54) Inverse Backscatter Absorption Gas Imaging

(71) Applicant: Wisconsin Alumni Research Foundation, Madison, WI (US)

(72) Inventors: Scott Sanders, Madison, WI (US); Matthias Beuting, Madison, WI (US)

(21) Appl. No.: 18/947,889

(22) Filed: Nov. 14, 2024

(51) Int. Cl. G01N 21/3504; G01M 3/04; G01N 21/65; G01S 17/89

(52) U.S. Cl. CPC G01N 21/3504; G01N 21/658; G01S 17/89; G01M 3/047; G01N 2021/3545; G01N 2201/0214

(57) ABSTRACT

Imaging of hydrogen and other dry gases with low light absorption is provided by an inverse backscatter gas absorption technique targeting absorption of surrounding water vapor to delineate a gas plume. Background distance characterization and modeling allow accurate quantification of leakage rate. A drone system provides for broad area leak surveys, leak characterization, and gas confirmation.

### BACKGROUND OF THE INVENTION

The present invention relates generally to backscatter absorption gas imaging (BAGI) and in particular to a method and apparatus for using BAGI for visualizing gases that are non-absorbing at BAGI light frequencies.

Hydrogen presents an attractive solution to many energy storage and generation problems because, unlike hydrocarbon fuels which release greenhouse gases and unburnt hydrocarbons during combustion, hydrogen combustion principally produces harmless water vapor. When hydrogen is used in a fuel cell, incidental combustion products like nitrous oxide, produced when atmospheric nitrogen and oxygen are exposed to high temperatures, can also be avoided. Hydrogen produced using clean energy technologies such as wind and solar can provide a mechanism for energy storage addressing some of the problems of irregular energy production by these technologies.

A practical challenge in developing the infrastructure necessary to generate, store, and transport hydrogen is detecting hydrogen leaks, a problem exacerbated by the small size of the hydrogen molecule (H₂). Leak detection for many gases may be performed using backscatter absorption gas imaging (BAGI) in which a camera produces a real-time video image of a leakage plume by measuring the absorption of backscattered infrared radiation. Unfortunately, hydrogen is transparent through most of the ultraviolet/visible/infrared atmospheric transmission window making conventional BAGI impractical.

### SUMMARY OF THE INVENTION

The present inventors have recognized that industrially produced hydrogen will typically be substantially free of water vapor, thus presenting the possibility of visualizing hydrogen leakage plumes by an inverse BAGI process (iBAGI) imaging the displacement of surrounding humid air. Importantly, the inventors have determined that this technique is practical at commonly available humidity levels and temperatures. A laser having frequency tuned for the measurement of water absorption provides a real-time negative image of the air surrounding the hydrogen plume. This negative image may be further processed to produce quantitative estimates of leakage rate. The invention contemplates additional image enhancement steps including background compensation and adjustment of the interrogating frequency to further improve signal-to-noise ratio and measurement accuracy.

In one embodiment, the invention provides a backscatter imaging apparatus having a light source with a narrowband wavelength within a range of 0.93 μm to 4.4 μm or in some cases 1.3 μm to 1.6 μm embracing a peak absorption by water vapor and adapted to be directed toward a gas field. A light sensor is positioned to monitor backscattered light to collect an absorption image of a plume of dry gas delineated by surrounding gas with greater water vapor content and to display and output information from the absorption image.

It is thus a feature of at least one embodiment of the invention to provide an apparatus for imaging of gases that do not have significant light absorption at readily measured light frequencies.

The apparatus may include a control circuit varying the wavelength of the illumination for different locations in the absorption image according to signal strength to improve signal-to-noise ratio of the measured backscattered light.

It is thus a feature of at least one embodiment of the invention to boost the acquired signal strength while preserving gas-distinguishing information.

In one embodiment the device may include a rangefinder measuring a distance related to a location of back scattering.

It is thus a feature of at least one embodiment of the invention to improve the image data by accounting for variations in backscatter distance such as may affect the ability to extract quantitative gas flow information from the image.

The rangefinder may be a LIDAR imager.

It is thus a feature of at least one embodiment of the invention to provide an optical range finding system compatible with the desire for remote measurement.

The light source used for backscatter imaging may be modulated for LIDAR phase ranging.

It is thus a feature of at least one embodiment of the invention to allow a single laser to perform both absorption and ranging operations.

The imager may further include processing circuitry processing the absorption image to determine an optical flow of the plume of dry gas.

It is thus a feature of at least one embodiment of the invention to provide information about gas flow velocity useful for quantizing gas leakage volume rates.

The imager may include a model receiving the absorption image to deduce the volume flow rate of the plume of dry gas.

It is thus a feature of at least one embodiment of the invention to provide a system that can quantify gas leakage.

In one embodiment the invention may be used with a drone system having a flying platform adapted for remote control. The platform may support a Raman spectrometer communicating with a hollow core optical fiber at least one meter in length and having an upper end receiving light from the Raman spectrometer and a lower end providing a mirror for receiving light through the hollow core optical fiber from the Raman spectrometer and reflecting the received light back to the Raman spectrometer through the hollow core fiber. An air compressor may circulate and/or compress air through or within the hollow core fiber.

It is thus a feature of at least one embodiment of the invention to provide a highly sensitive gas detector for gases such as hydrogen that can be used for surveys of gas leakage in a drone type system.

The drone system may include a retractor mechanism for retracting the optical fiber and extending the optical fiber under motor control.

It is thus a feature of at least one embodiment of the invention to permit the use of a substantial length of optical fiber for sensitivity without compromising the ability to take off and land or move through obstructed areas.

These particular objects and advantages may apply to only some embodiments falling within the claims and thus do not define the scope of the invention.

### BRIEF DESCRIPTION OF THE DRAWINGS

FIG. 1 is a simplified diagram of a multi-drone system for implementing one embodiment of the present invention including a survey drone for detecting low concentrations of hydrogen, an iBAGI drone for plume imaging, and an optional sampling drone to confirm chemical species of the plume.

FIG. 2 is a flowchart depicting a sequential operation of the drones of FIG. 1;

FIG. 3 is a fragmentary diagram of a hydrogen sensor system for use on the survey drone of FIG. 1 showing, in a first inset, components of a Raman spectrometer operating with a hollow fiber and showing, in a second inset, a mirror for reflecting light from the Raman spectrometer and compressor for charging the hollow fiber;

FIG. 4 is a diagram of an iBAGI camera on the iBAGI drone incorporating both scatter detection and optical LIDAR;

FIG. 5 is an absorption spectrum of water vapor showing a scanning frequency range;

FIG. 6 is a flowchart showing the processing of data from the iBAGI drone;

FIG. 7 is a diagrammatic representation of the operation of the iBAGI camera with respect to determining a range of a backscatter medium; and

FIG. 8 is a block diagram of an image processing system such as a machine learning system for deducing flow rate from image data obtained by the iBAGI camera.

### DETAILED DESCRIPTION OF THE PREFERRED EMBODIMENT

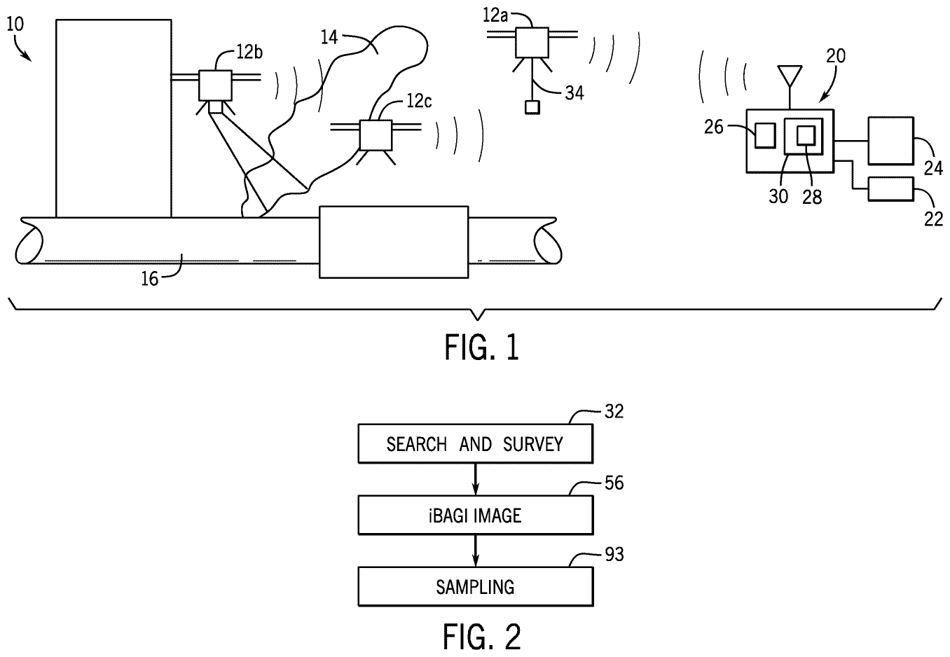

Referring now to FIG. 1, a gas leakage detection system 10, in one embodiment, may provide for up to three drones 12 including: a survey drone 12a, an iBAGI imaging drone 12b, and a sampling drone 12c. These drones may operate in coordination for finding and making measurements of a gas plume 14, for example, from leakage of hydrogen from hydrogen production or storage equipment 16.

In this regard, each drone 12 may be in communication with a base station 20 allowing manual or automatic control of the drones 12 and the transmission of measurement data from the drones 12 to the base station 20. Typically, the communication will be via a radio communication links, although a tethered communication system is also contemplated.

The base station 20 will typically provide user controls 22 and a graphic display 24, for example, for displaying images of the plume 14 and quantitative data derived from those images. In this regard, base station 20 may include one or more processors 26 executing a stored program 28 contained in computer memory 30. Generally both the drones 12 and the base station 20 provide for computational ability, and the below described computational operations may be freely distributed between the two.

In one nonlimiting embodiment, the drones 12 may be industrial grade commercial quadcopters, for example, commercially available from DJI of Shenzhen, China, under the trade name DJI Matrice 350 RTK and offering up to 2.7 kg of payload and 55 minutes of flight time with radar obstacle avoidance and autonomous guidance. Ideally, but not necessarily, the drones are sized to fly in confined spaces, for example, having a maximum dimension of less than 100 cm, and in the rain and wind conditions of up to 40 km/h.

Referring now to FIG. 2, through manual or automatic operation, the base station 20 may enable the control of the drones 12 to, as indicated by process block 32, conduct a survey of an area where a leak may be. For this purpose, the drone 12a may be controlled to provide a regular flight pattern, for example, circling with decreasing radius a suspected location of a leak, or conducting a random or regular traversal of an area where leakage must be assessed.

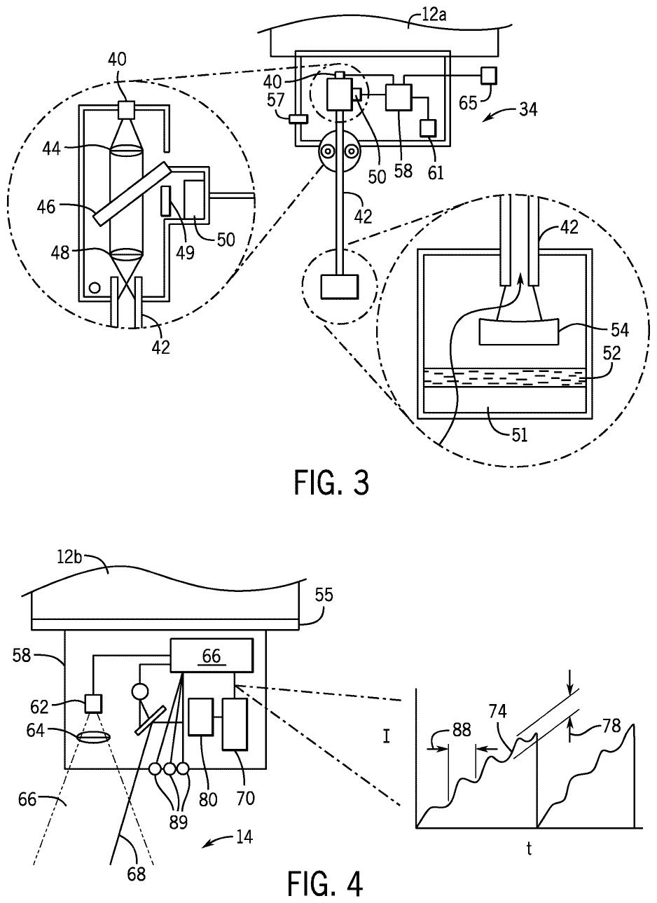

Referring now to FIG. 3, for the purpose of this survey operation, drone 12a may carry with it a hydrogen sensor 34 which in one embodiment may be an off-the-shelf sensor, for example, commercially available from 21 Sense of Houston, Texas, under the trade name of H2 IntelliSense Slim Hydrogen Sensor. Such a sensor provides hydrogen sensitivity as low as 50 ppm.

In a second embodiment, the hydrogen sensor 34 may be a pressurized hollow fiber Raman scattering sensor providing sensitivity of less than 50 ppm and a response time of much less than the 10 s typical of currently commercially available hydrogen sensors. This latter sensor makes use of fiber-enhanced spontaneous Raman scattering and has a simulated detection limit of <1 ppm at a response time of <10 s.

Referring particularly to FIG. 3, in this latter design, blue light from a commercial GaN diode laser 40 (for example, commercially available from Nichia Corporation of Japan under the trade name of Nichia NDB 4916) having a frequency of 450 nm at 0.5 Watts is conducted through a first collimating lens 44 and a dichroic beam splitting mirror 46 and then through a second lens 48 into a center bore of a hollow photonic crystal fiber 42 (for example, similar to iXblue IXF-ARF-40-240 commercially available from iXBlue of Paris, France).

Raman scattering from gas contained in the fiber 42 and emerging upward at the top of the hollow fiber 42 is spectrally selected using a dichroic mirror 46 and bandpass filter 49 and detected by a sensitive amplified photodiode 50.

The hollow fiber 42 may be three meters long and is filled with the gas under test as pressurized and circulated by a micro-compressor 51 introducing filtered air through filter 52 into the bottom of the fiber 42. The compressor 51, for example, may be a commercially available pump providing pressures as high as 150 psi with flow rates of 10⁻⁹ to 10⁻¹³ kg/s. Fiber pressurization increases the Raman signal because the Raman signal scales with gas number density and reduces the sensor time constant by pushing sample gas through the small-core fiber more quickly. A vent 57 allows exhaust of the measured gas.

Both laser light from diode laser 40 and forward-scattered Raman light are returned into the fiber 42 using a concave spherical mirror 54 positioned in alignment below the bottom of the fiber 42, this reflection doubling the light path through the gas and further enhancing the Raman signal. Because Raman interference from H₂O vapor can contaminate the H₂ Raman signal of interest especially near 1 ppm H₂ concentration, a humidity sensor 61 on the drone is used to correct the Raman signal for H₂O interference via onboard processor and telemetry circuit 58 or at the base station 20. The drone 12a may also provide GPS altitude and wind speed and direction sensors 65 that will aid in identifying a leak location source when gas is detected at a given location by extrapolating backward to a source of the leak using wind speed and velocity.

In one embodiment, the fiber 42 may have a length of at least 3 m (typically greater than 1 m) to move the gas sampling point away from the drone 12 a to minimize fluid-mechanic interference from drone downwash. A motorized retraction pulley 59 may be used to retract the fiber 42 by coiling during takeoff and landing of the drone 12a.

Referring now again to FIGS. 1 and 2, if a survey per process block 32 identifies the location of a hydrogen leak, then at process block 56, the iBAGI drone 12c may be dispatched to that location for imaging of the plume 14.

Referring now also to FIG. 4, for this purpose the iBAGI drone 12b may hold an iBAGI camera 63 on a motorized gimbal 55 for backscatter absorption gas imaging using an inverse approach in which the measured absorption of backscatter is largely that of the gas surrounding the plume 14.

In one embodiment, the iBAGI camera 63 may include an onboard processor 60 program to receive input from a photodetector 62 having a lens system 64 capturing a field-of-view 67 directed at the plume 14 and typically covering an area 0.8-4 m in diameter at a standoff distance from 2 to 10 m. The photodetector will be sensitive to a region around the absorption of water vapor, for example, from 0.93-4.4 μm or 1.3-1.6 μm.

An image is developed by a scanning laser beam 68, for example, from a fiber coupled tunable IR laser 70 directed by a pivoting mirror 72 under control of the processor/transceiver 60 to scan in a raster pattern over the field-of-view 67. Generally the laser 70 will be an infrared laser having a center frequency of approximately 1.37 μm and scannable within the range 76 of 1.3-1.6 μm and having a narrow bandwidth of approximately 200 kHz and typically less than 1 MHz.

During this scanning, the laser 70 may be modulated with a current 74 following in the form of a ramp or sawtooth waveform causing the laser frequency to sweep through a defined frequency range 76 (for example, 1.3-1.6 μm) shown in FIG. 4. Superimposed on this ramp may be a sinusoidal modulation 78 used for LIDAR (light detection and ranging) range finding using ranging detector 80. For example, the system may deduce time-of-flight of laser signals using light phase interferometry.

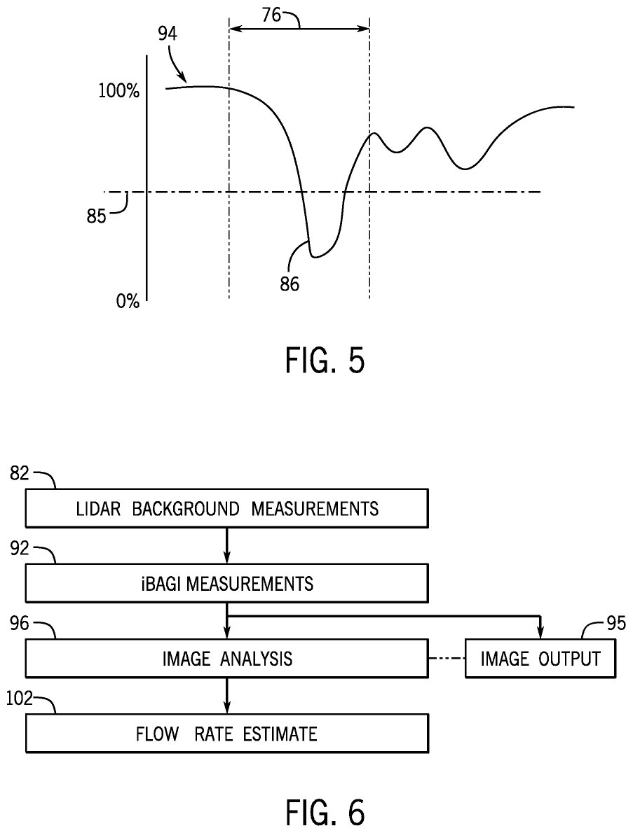

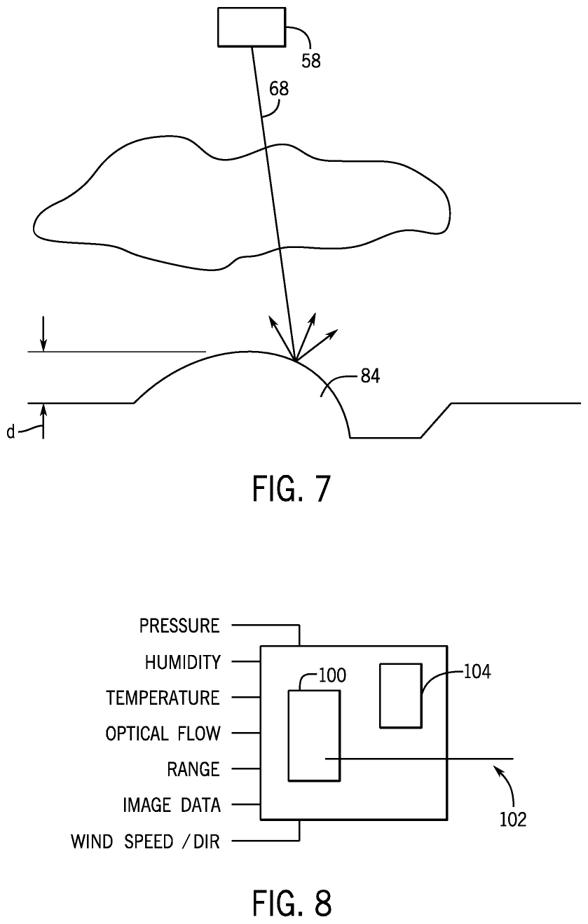

Referring now to FIG. 6, operation of the iBAGI drone 12b may permit a number of different measurements processed by the processor/transceiver 60 or the base station 20. These components may execute a program beginning at process block 82 by making LIDAR range measurements of back scattering material 84 positioned behind the plume 14 with respect to the camera 63. In making these measurements, a laser 70 may select a center frequency displaced slightly from a peak absorption 86 of water (shown in FIG. 5) so as to provide suitable signal-to-noise ratio level by adjusting the frequency to provide a level 85 selected to provide a strong signal while still being strongly coupled to water absorption. For example, the range measurements may be made at a predetermined time slice 88 during the waveform of the driving current 74 shown in FIG. 4. Note generally that the sinusoidal modulation 78 may be confined to this time slice 88. The location of the time slice 88 may be adjusted on a pixel-by-pixel basis to maximize signal-to-noise ratio in the LIDAR measurements to provide an output related to the position of the time slice 88 and hence the frequency of measurement being correlated to backscatter absorption. These LIDAR measurements which indicate the distance (d) of the backscatter at different portions of the image may optionally be used to correct the backscatter measurements for quantitative assessment of the amount of hydrogen in the plume 14 caused by varying amounts of absorbing water vapor between the backscatter point and camera 63.

The iBAGI drone 12b may also make humidity, barometric pressure, wind speed and direction, and temperature measurements using sensors 89 as provided to the processor/transceiver 60.

Referring again to FIG. 4 and process block 92, contemporary with the above measurements, camera 63 is then employed to collect image data indicating backscatter absorption over the field-of-view 66, being the light from backscattered radiation absorbed by the intervening gases. In this process at each location of the mirror 72 representing an image pixel, a cycle of the current waveform shown in FIG. 4 is completed representing a frequency sweep, and the return light measured by the photodetector 62 used to identify an offset of the time slice 88 providing the desired signal level 85 (shown in FIG. 5). The center frequency of the time slice 88 is then used to generate the pixel data being essentially a frequency image that operates as a proxy to indicate the amount of backscatter absorption while ensuring strong signal-to-noise ratio.

At each point in the scan, a backscatter correction measurement may be made by also collecting data at a shelf region 94 of no or minimal water absorption. Dividing the above water absorption values provided by signal level 85 by corresponding values of absorption independent of water in the shelf region 94 corrects for variations in backscatter. Otherwise, variations in amounts of backscatter independent of absorption by material of the plume 14 can introduce errors apparent absorption of the plume 14.

This image data may be processed to correct for variations in the background material 84 that change the intensity of the backscatter thus affecting the apparent absorption, for example, normalizing the deduced backscatter image brightness according to proximity of the background material 84. Other image processing techniques, for example, to boost contrast, edge detector or the like, may also be employed.

In one variation, the determination of absorption may make use of wavelength modulated spectroscopy, for example, as described in Stéphane Schilt, Luc Thévenaz, and Philippe Robert, “Wavelength modulation spectroscopy: combined frequency and intensity laser modulation,” Appl. Opt. 42, 6728-6738 (2003).

The resulting process image may then be output on display 24 (of FIG. 1) per process block 95.

The raw backscatter data or processed image data is next processed, typically at the base station 20, per process block 96 to deduce quantitative features of the plume 14, including, for example, volumetric flow rate and concentration. In this analysis, a variety of different image analysis techniques may be employed including, for example, performing optical flow analysis on the image data which may both better identify the plume (as material that is flowing) and estimate an average areal flow rate of gas in the plume necessary for quantifying a leakage rate which may be augmented by wind speed information. Plume identification may also be performed based on a histogram analysis of backscatter.

Identification of the plume 14 allows a two-dimensional area of the plume 14 to be determined and for the plume volume to be approximated by rotation of this area about the principal axis of optical flow to produce a volume rate under an approximation of plume symmetry. A concentration of gas in the plume 14 may be determined by variations in backscatter absorption and/or through the use of a model prepared from empirically derived or simulated data held in lookup tables providing estimates for a variety of backscatter intensities corrected for temperature, barometric pressure, and humidity and wind speed.

Alternatively and referring to FIG. 8, the quantitative assessments of the plume 14 may be generated by a model using a machine learning system 100 trained with a training set, for example, generated under control laboratory conditions, providing for a range of leakage rates with different humidities, pressures, and windspeed. The training set will generally include a pressure measurement, humidity measurement, temperature measurement, optical flow characterization over an image, backscatter absorption over the image, range of backscatter, and windspeed.

The result is a set of trained weights 104 allowing the machine learning system 100 to receive image data, range, optical flow, temperature, humidity, and pressure from actual field measurements to provide a flow characterization data 102 according to techniques generally understood in the art.

Quantitative data derived at image process block 96 may also be used to augment the image displayed at process block 95, for example, by overlaying color images or quantitative data composited with the image.

Although a drone system is described above, the inventors also contemplate an alternate embodiment of a handheld device incorporating the imaging functionality of the iBAGI drone as discussed above. In either case the leakage detection system provides a convenient imaging of otherwise invisible gas plumes from a safe distance, typically 5 m or more.

Referring now again to FIGS. 1 and 2, after characterization of the plume 14, the sampler drone 12c may be positioned within the identified plume 14 to confirm that the dry gas displacing humid surrounding area is in fact hydrogen per process block 93.

It will be appreciated that the drone 12c or 12b may also make confirmation of the gas of the plume 14 by employing standard BAGI with laser frequencies selected to be readily absorbed by other species, for example, CO₂ which may then be used to identify hydrogen leaks by process of elimination.

Except as discussed above, the present system may employ known technologies for BAGI, for example, as described in McRae, T. G., & Kulp, T. J. (1993), Backscatter absorption gas imaging: a new technique for gas visualization, hereby incorporated by reference.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a processor” and “computer” or the like can be understood to include one or more microprocessors or computers or functionally equivalent circuitry that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention should be understood to not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A method of imaging comprising:
(a) illuminating a gas volume with light providing a narrowband wavelength between 0.93 and 4.4 μm in a range including a measurable absorption feature present in ambient air;
(b) monitoring backscattered light to collect an absorption image of a plume of gas having an absorption less than that of the absorption feature delineated by a surrounding gas with the absorption feature; and
(c) displaying image information from the absorption image.

2. The method of claim 1 further including varying the wavelength of the illumination for different locations in the absorption image according to signal strength to improve signal-to-noise ratio of the monitored backscattered light.

3. The method of claim 1 further including, prior to (c), characterizing the backscattered light absent absorption by the gas volume to correct the absorption image for variations in backscatter light.

4. The method of claim 3 wherein the characterization of backscattered light determines a distance related to a location of back scattering.

5. The method of claim 4 wherein the distance is provided by LIDAR imaging.

6. The method of claim 5 wherein the step of illuminating uses a scanned laser modulated for LIDAR phase ranging.

7. The method of claim 1 further including analyzing the absorption image to determine an optical flow of the plume of dry gas.

8. The method of claim 1 further including applying the absorption image to a model of gas dynamics to deduce a volume flow rate of the plume of dry gas.

9. The method of claim 1 wherein the absorption feature is water vapor.

10. A backscatter imaging apparatus comprising:
(a) a light source having a narrowband wavelength within a range of 0.93 and 4.4 μm including a measurable absorption feature present in ambient air and adapted to be directed toward a gas field;
(b) a light sensor position to monitor backscattered light to collect an absorption image of a plume of gas delineated by surrounding gas having a greater concentration of the absorption feature; and
(c) a display outputting information from the absorption image.

11. The apparatus of claim 10 further including a control circuit varying the wavelength of the light source for different locations in the absorption image according to signal strength to improve signal-to-noise ratio of the measured backscattered light.

12. The apparatus of claim 10 further including a rangefinder measuring a distance related to a location of back scattering.

13. The apparatus of claim 12 wherein rangefinder is a LIDAR imager.

14. The apparatus of claim 13 wherein the light source is modulated for LIDAR phase ranging.

15. The apparatus of claim 10 further including processing circuitry processing the absorption image to determine an optical flow of the plume of dry gas.

16. The apparatus of claim 10 further including a model receiving the absorption image to deduce a volume flow rate of the plume of dry gas.

17. A drone system comprising:
a flying platform adapted for remote control;
a Raman spectrometer supported by the flying platform;
a hollow core optical fiber at least one meter in length and having an upper end communicating with the Raman spectrometer and a lower end providing a mirror for receiving light through the hollow core optical fiber from the Raman spectrometer and reflecting received light back to the Raman spectrometer through the hollow core fiber; and
an air compressor circulating air through the hollow core fiber.

18. The drain system of claim 17 further including a retractor mechanism for retracting the optical fiber and extending the optical fiber under motor control.
